(19) United States
(12) Patent Application Publication
(10) Pub. No.: US 2008/0216013 A1
(43) Pub. Date: Sep. 4, 2008

(54) Patent tracking

(76) Inventors: Steven W. Lundberg, Edina, MN (US); Janal M. Kalis, Minneapolis, MN (US)

Correspondence Address: SCHWEGMAN, LUNDBERG & WOESSNER, P.A., P.O. BOX 2938, MINNEAPOLIS, MN, 55402, US

(21) Appl. No.: 11/888,632

(22) Filed: Aug. 1, 2007

Related U.S. Application Data
(60) Provisional application No. 60/834,608, filed on Aug. 1, 2006.

(51) Int. Cl. G06F 3/048

(52) U.S. Cl. 715/803; 715/764; 715/781

(57) ABSTRACT

Systems and methods for patent and claim tracking are described. Embodiments include tracking changes in claims through amendments, and displaying the claims in a marked-up format for viewing the changes. Other embodiments include recording and displaying references that may have been cited against a patent application and its claims. Other embodiments are described and claimed.

### RELATED APPLICATION

This application claims the benefit of U.S. Provisional Application Ser. No. 60/834,608 entitled “Patent Tracking,” filed on Aug. 1, 2006, which application is incorporated herein by reference.

### TECHNICAL FIELD

The invention relates generally to the field of patent tracking, and more specifically to methods and systems to provide patent tracking.

### COMPUTER PROGRAM LISTING APPENDICES

This application includes two appendixes. Appendix A is a listing of source code found on the two identical compact discs, each disc created on Oct. 16, 2006 and having a size of 2.88 MB, which comprise Appendix B. Appendix A includes the path, name, creation date, and file size of all 399 files on each compact disc of Appendix B. Appendix A and Appendix B are incorporated herein by reference.

### BACKGROUND

Some systems exist which allow viewing of the prosecution history of issued patents and pending applications. Some systems allow a user to view communications between a inventor or agent of the inventor and a patent office. Tracking of a patent application through the prosecution process may be useful for portfolio management purposes, for efficient prosecution purposes or other purposes.

### BRIEF DESCRIPTION OF THE DRAWINGS

FIG. 1 is a flow diagram of a method for tracking claims through prosecution according to various embodiments.

FIG. 2 is a flow diagram of an example claim being tracked through prosecution according to an embodiment.

FIG. 3 is a block diagram of a system for tracking patent application data according to various embodiments.

FIGS. 4-43 are graphical illustrations of screenshots of a claim tracking tool according to various embodiments.

### DETAILED DESCRIPTION

Methods and systems to track patents and related documents are described. In the following description, for purposes of explanation, numerous specific details are set forth in order to provide an understanding of various embodiments of the inventive subject matter. It will be evident, however, to one skilled in the art that embodiments of the inventive subject matter may be practiced without these specific details.

In an embodiment, claims are tracked throughout prosecution with the Patent and Trademark Office (PTO). In such an embodiment, one or more graphical user interface screens are provided to present different views of claims, patent documents, and other PTO correspondence. Examples of such graphical user interface screens are described in further detail below. In an embodiment, software and hardware combine to form a ClaimTracker system, wherein such a system is capable of tracking claims, patent-related documents, reference documents, and the like in a comprehensive graphical user interface.

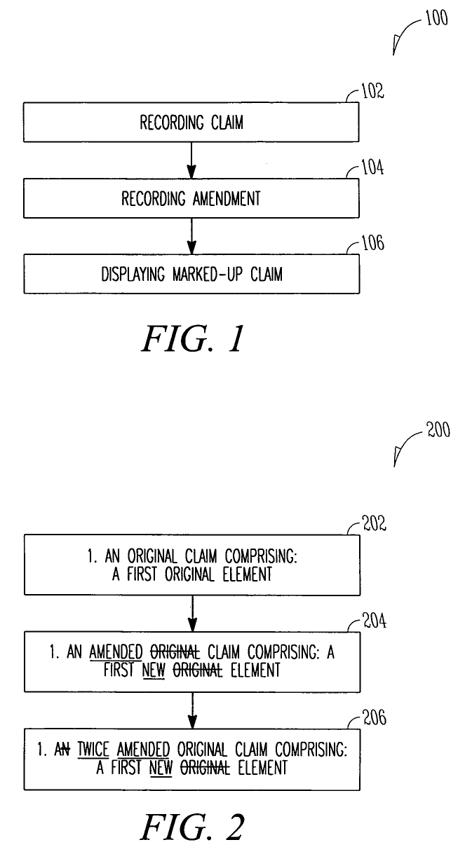

FIG. 1 is a flow diagram of a method 100 for tracking claims through prosecution according to various embodiments. The method 100 begins with recording a claim related to a patent application (block 102). The claim may be one of a number of claims which may be recorded into a claim tracking system. The claims may be automatically added or manually input into the system for recording. The claim or claims recorded into the system may be referred to as the original version of the claim or claims, and may represent the claim or claims as filed. Following the recording of the original claims, an amendment may be recorded (block 104). The amendment may arise through prosecution in response to a communication from the PTO—in response to an office action for example. The amendment may also arise separate from an office action, as a preliminary or supplemental amendment for example. The amendment may include alterations to one or more of the claims. The amended claims may be recorded, and may then be displayed in a way that highlights the changes. The claims may be displayed in their “marked-up” form to quickly and easily illustrate the changes that have been made (block 106).

FIG. 2 is a flow diagram 200 of an example claim being tracked through prosecution according to an embodiment. The flow diagram 200 includes an example original claim 202, a first amended version of the claim 204, and a twice amended version of the claim 206.

The original claim 202 may be an original claim as filed, or may represent some other starting point through the prosecution process. According to some embodiments, the original claim 202, may itself be an amendment of a previous claim. The first amended version of the claim 204 may be shown in a marked up form with underlines to indicate additions and strikethroughs to represent deletions. Other methods of illustrating additions, deletions or other changes may be used as well, and this description is not limited in that respect. Colors, the use of bold, or highlighting, italics or other methods may be used as well. The twice amended version of the claim 206 may illustrate all of the changes since the original claim. According to some embodiments, the twice amended version of the claim 206 may only show changes between it and the previous version of the claim.

Additional amended versions of the claim are also contemplated according to various embodiments. Any number of additional amended versions of the claim may be added and displayed in a marked up form to show the progression of changes from one amendment to the next. It is also contemplated that views may be selected to display changes between groups of amended versions of the claims, or to see the state of a claim at a specific point in prosecution.

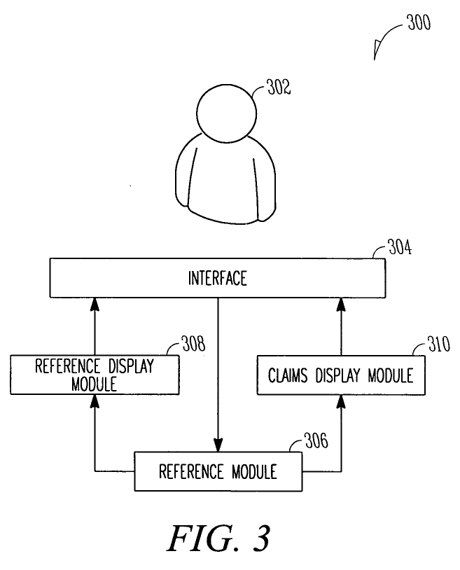

FIG. 3 is a block diagram of a system 300 for tracking patent application data according to various embodiments. The system includes an interface 304 to be accessed by a user 302, a reference module 306, a reference display module 308, and a claims display module 310.

The user 302 may access the interface 304, which may be a web based interface or other type of computer based interface according to various embodiments. The type of interface is not limiting to this description. The interface 304 may be used to record communications related to patent applications. These communications may include application filings, office actions, responses, amendments, and other documents exchanged with the PTO during the prosecution of a patent application. Some of the communications may include references which may be considered prior art references. These references may include issued patents, published application, non-patent publication or others. The references may be recorded along with their association to the communication from which they originated. The reference module 306 may record the references and the appropriate associations. In some cases, the references will relate to one or more claims in a particular patent application. In those cases, the references will be associated with those claims by the reference module 306.

The reference display module 308 may use the references and associations recorded by the reference module to display information to the user 302. The reference display module may display one or more references and the associated patent applications, communication and claims. The claims display module 310 may similarly display one or more claims and the associated references. The claims display module may also display associations between claims having the same associated reference. In some cases one or more claims in one patent application may be associated with a reference which is associated with one or more claims in a separate patent application. The claims display module 310 may display these associations to the user 302. This allows the user to view claims in separate patent application through prosecution with regard to references cited against the claims. Seeing how one claim is amended in light of a particular reference may aid in the prosecution of another claim facing the same reference.

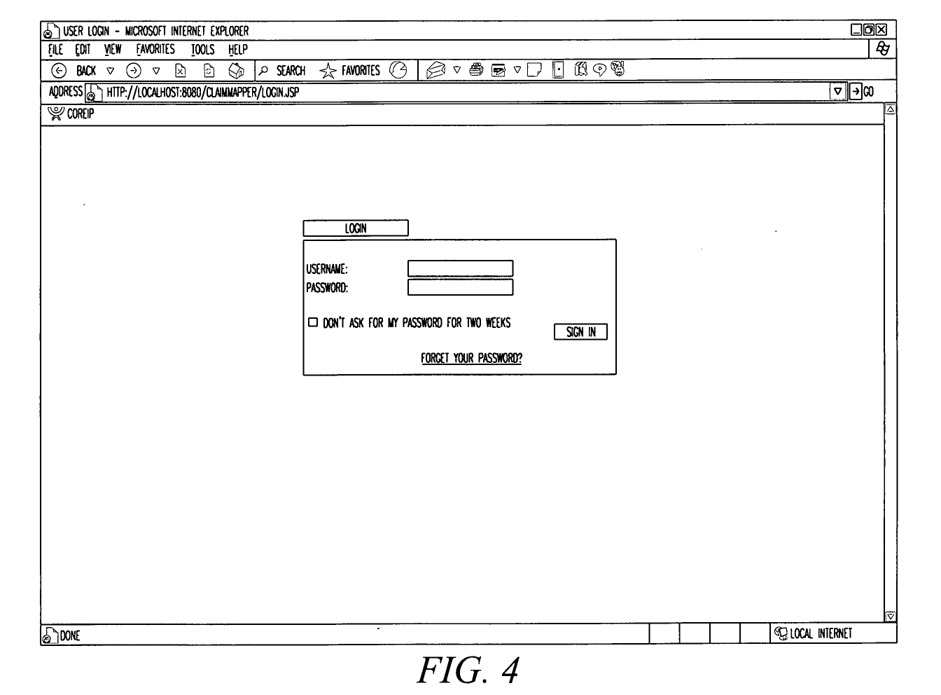

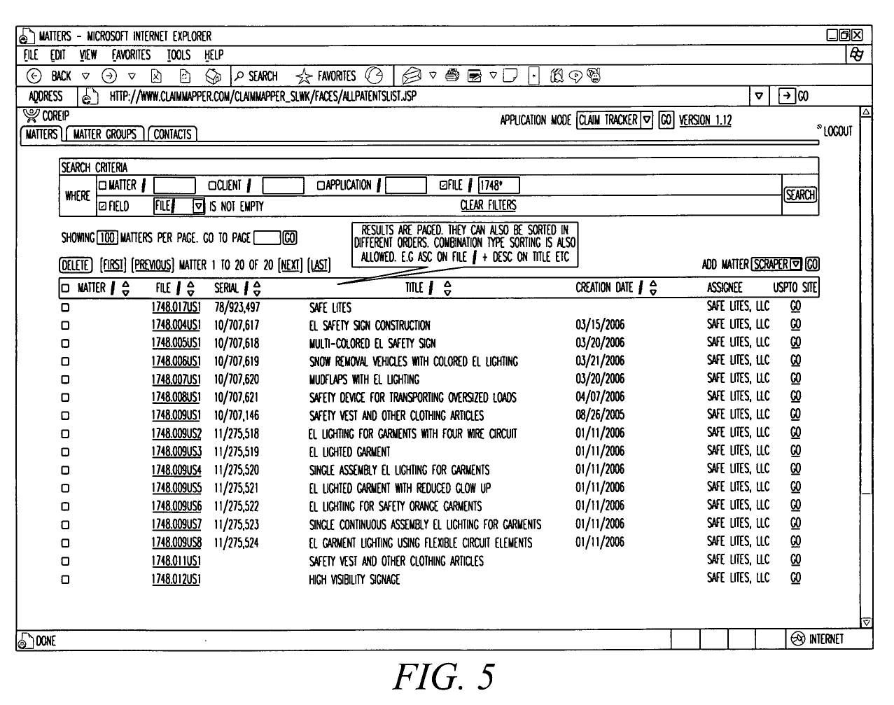

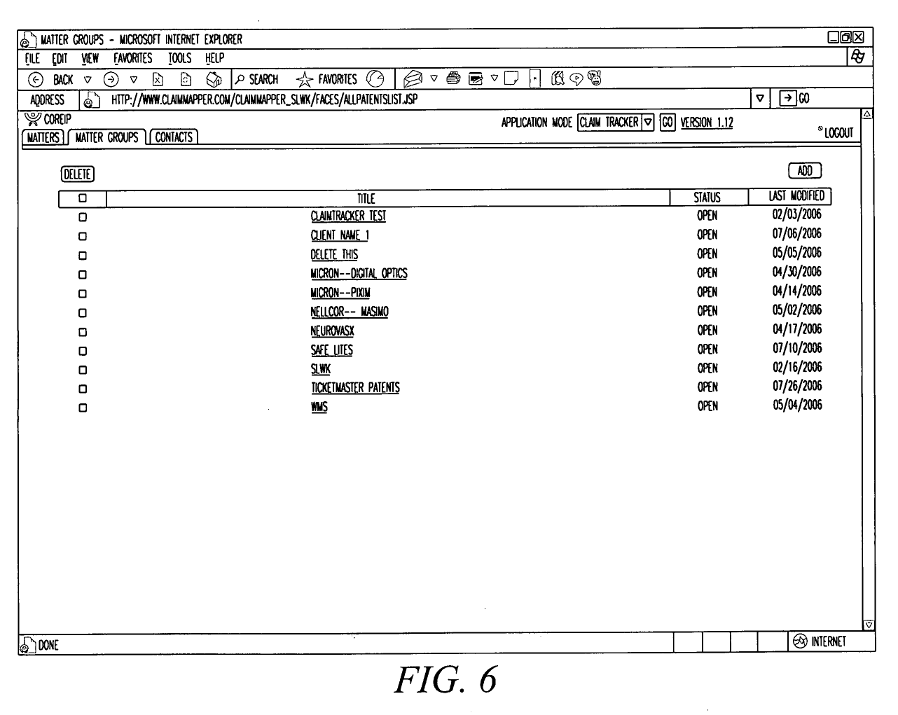

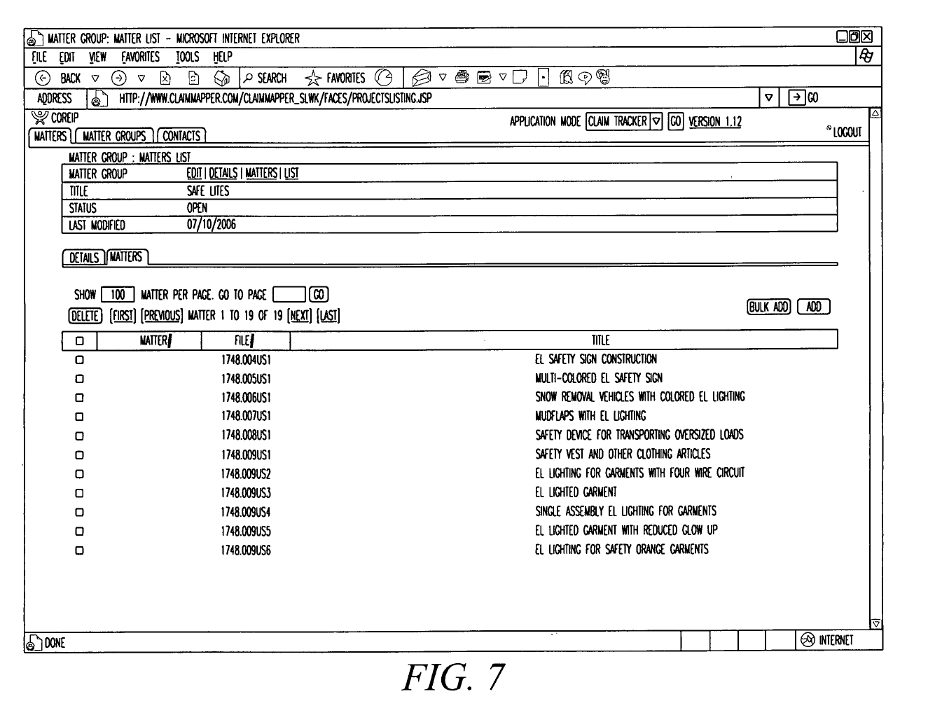

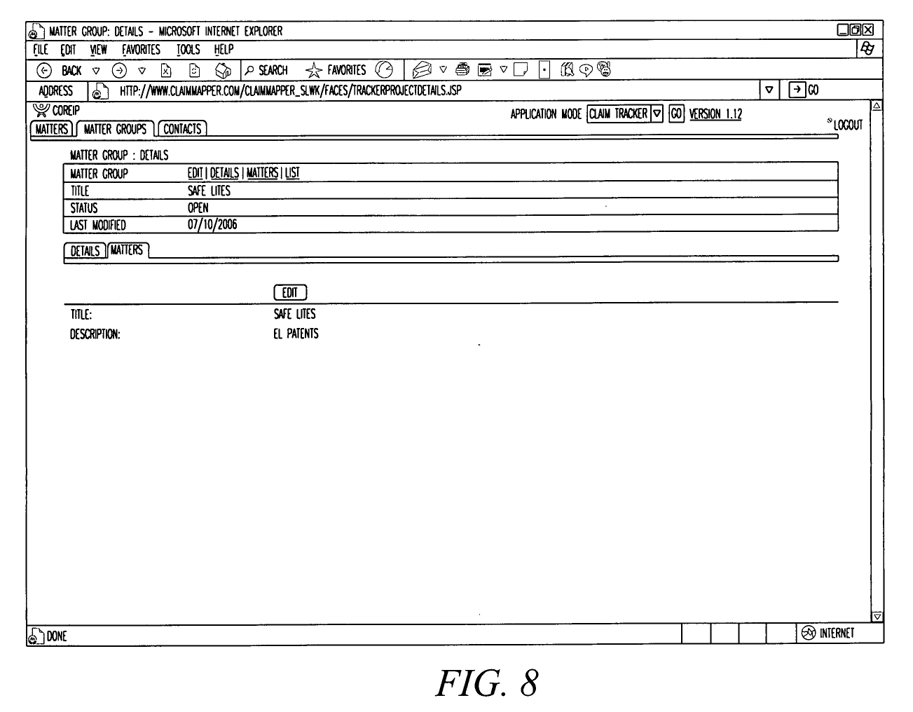

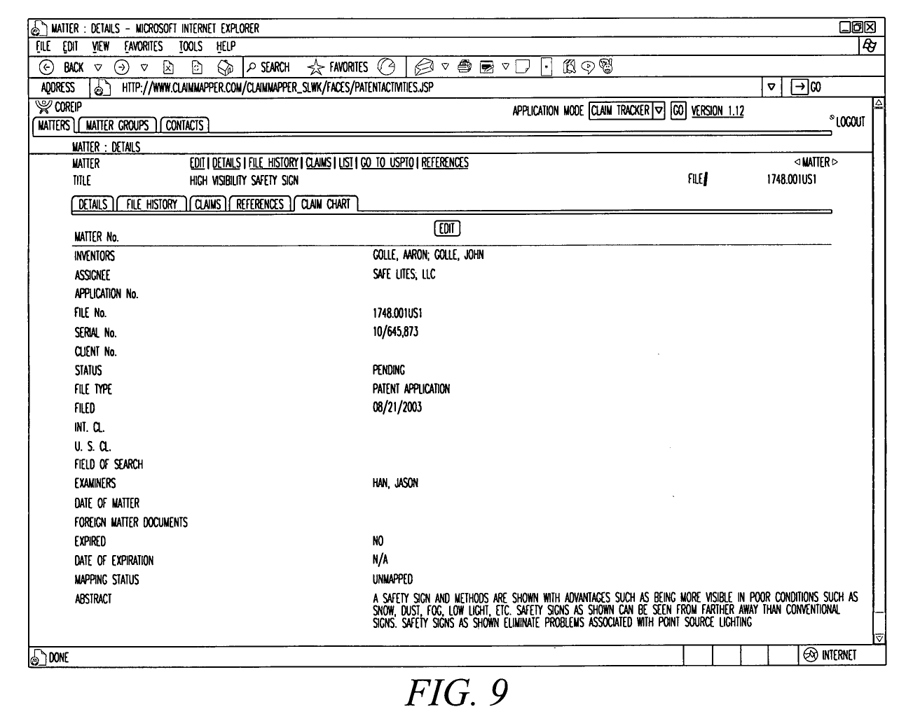

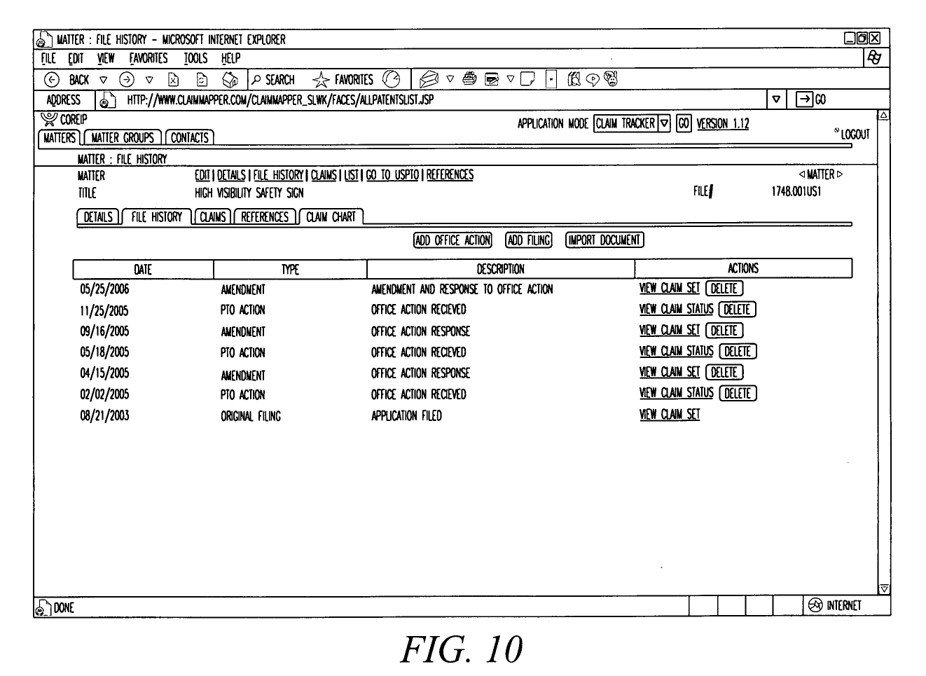

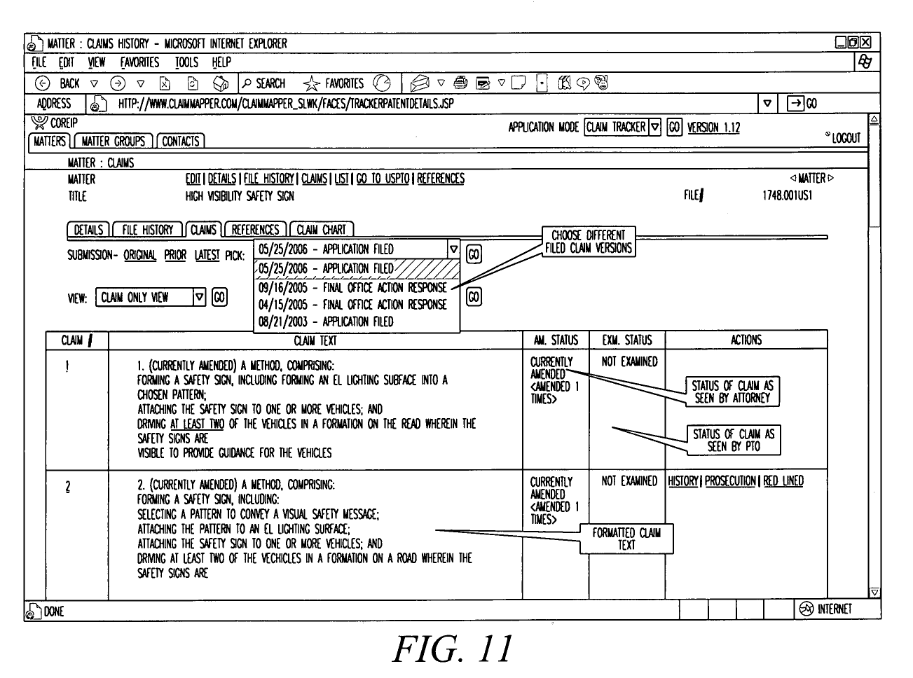

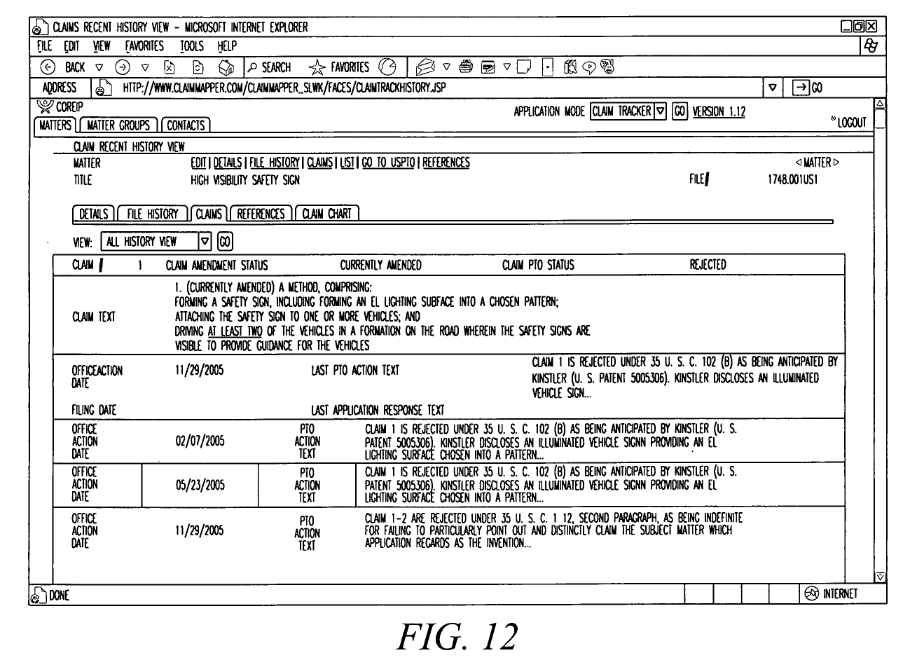

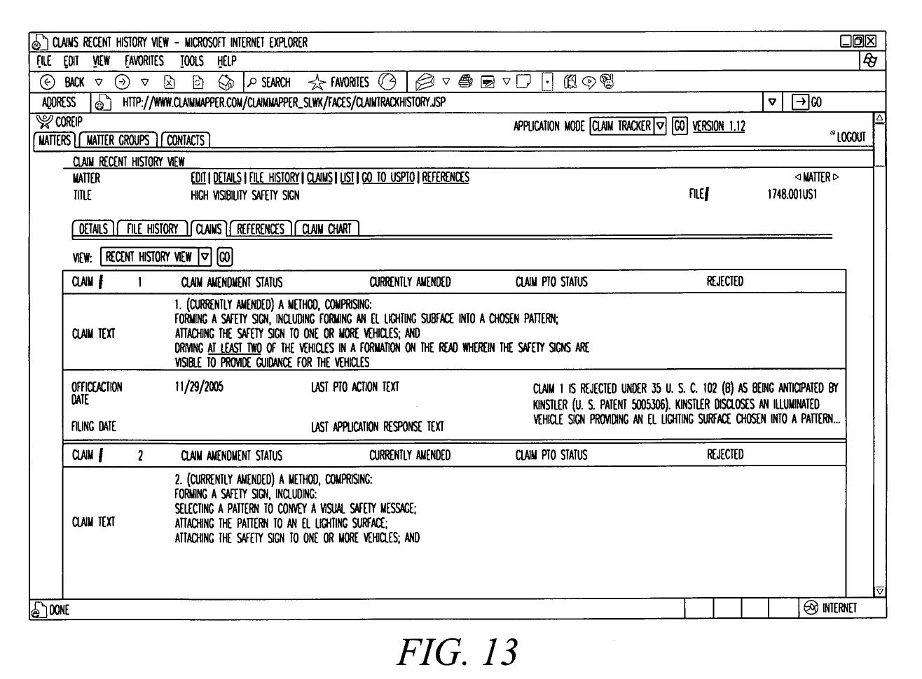

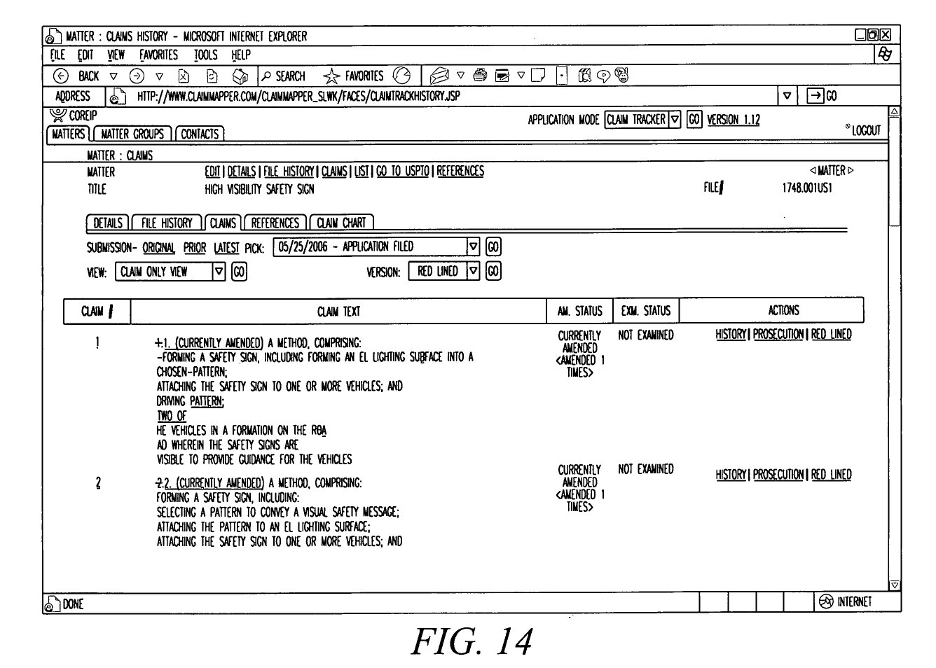

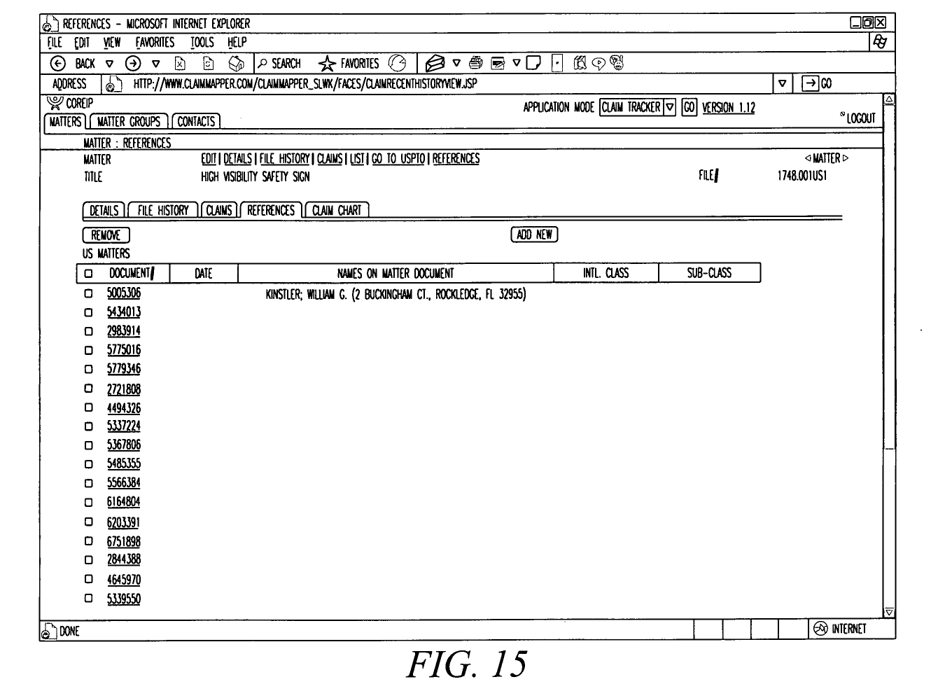

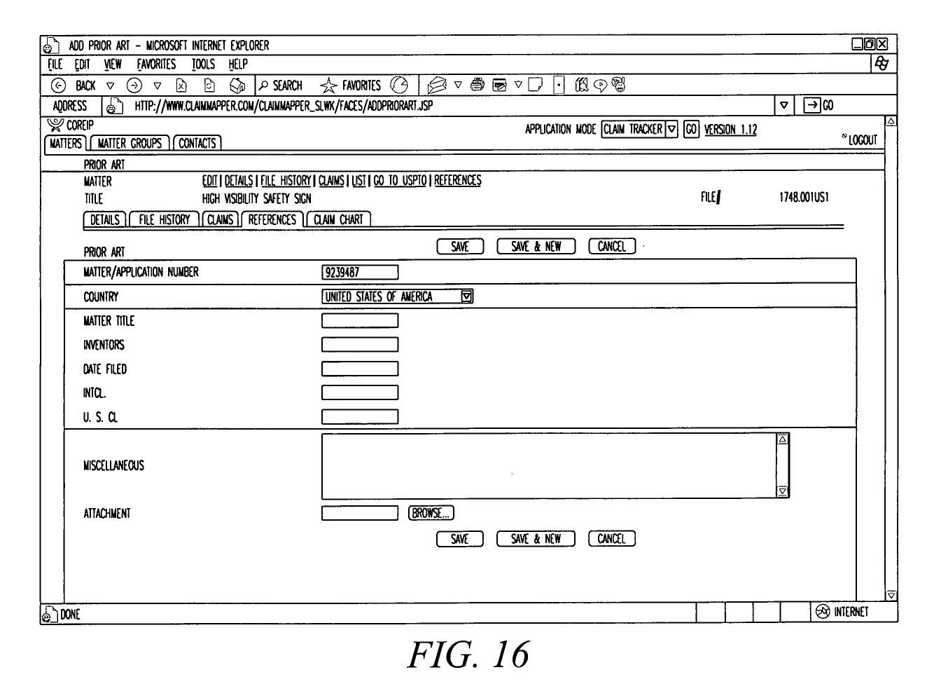

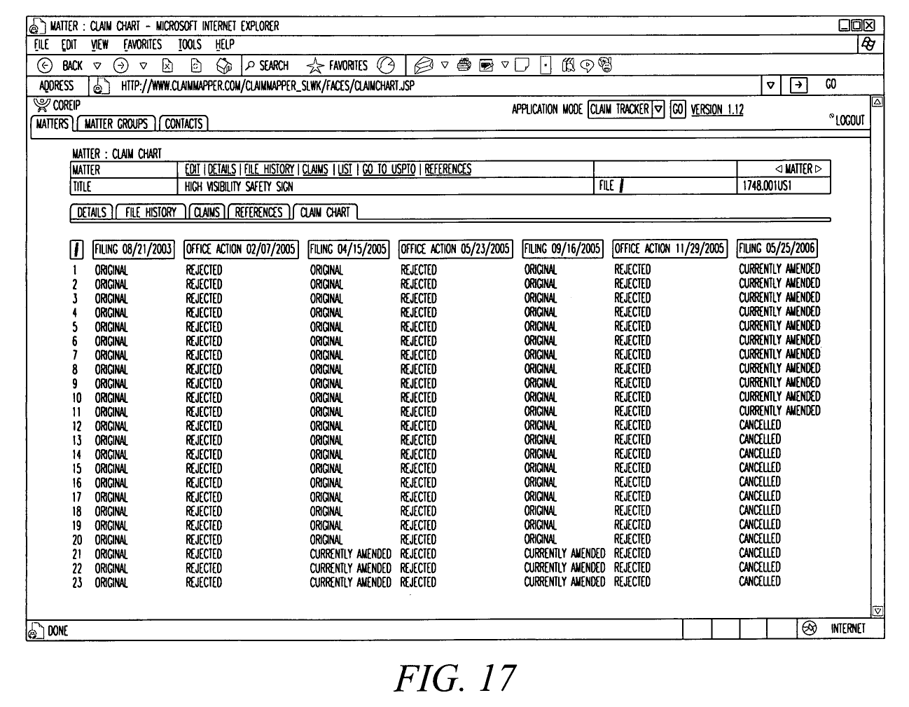

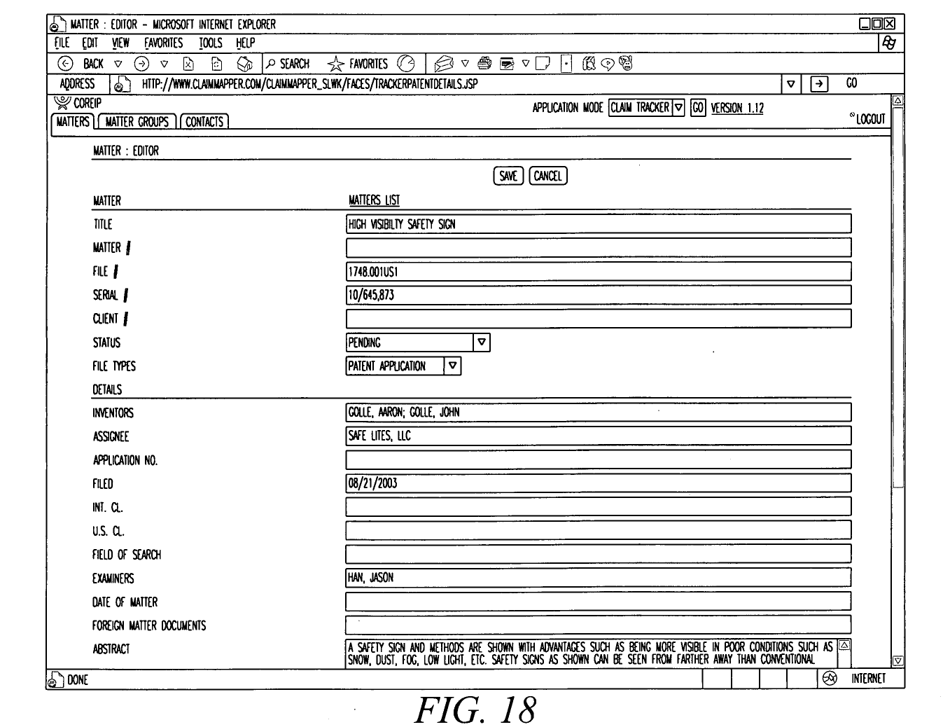

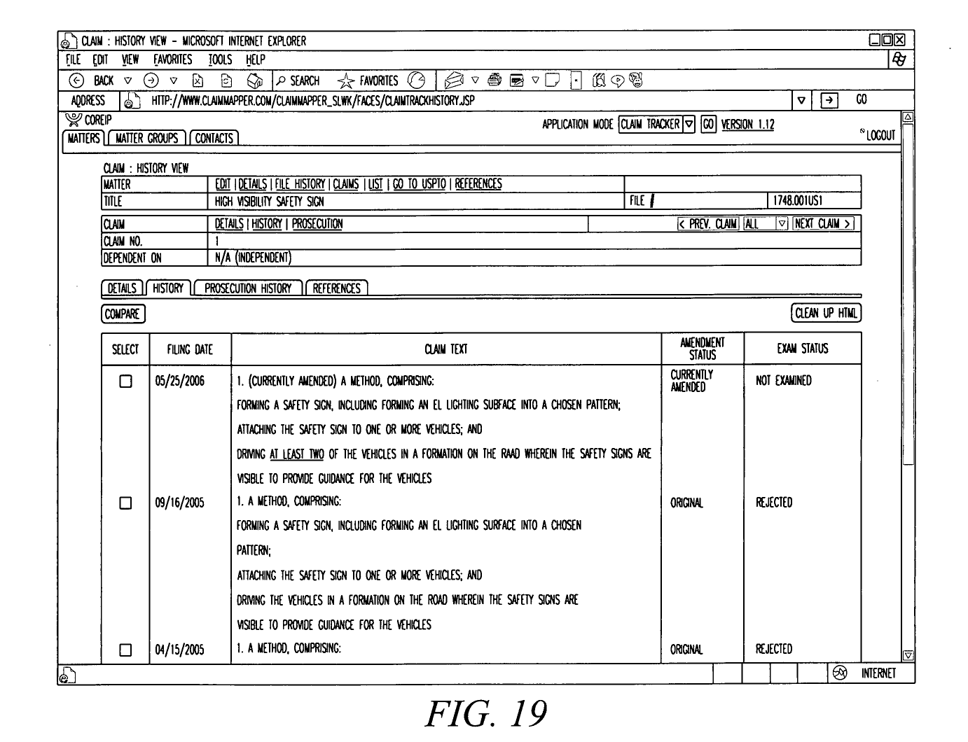

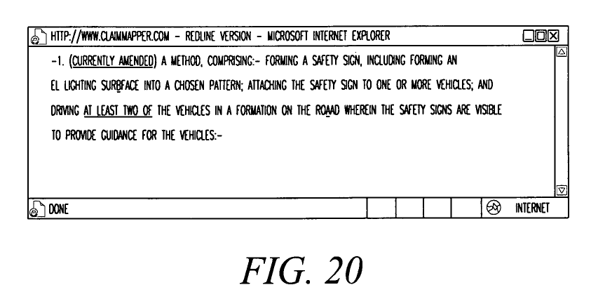

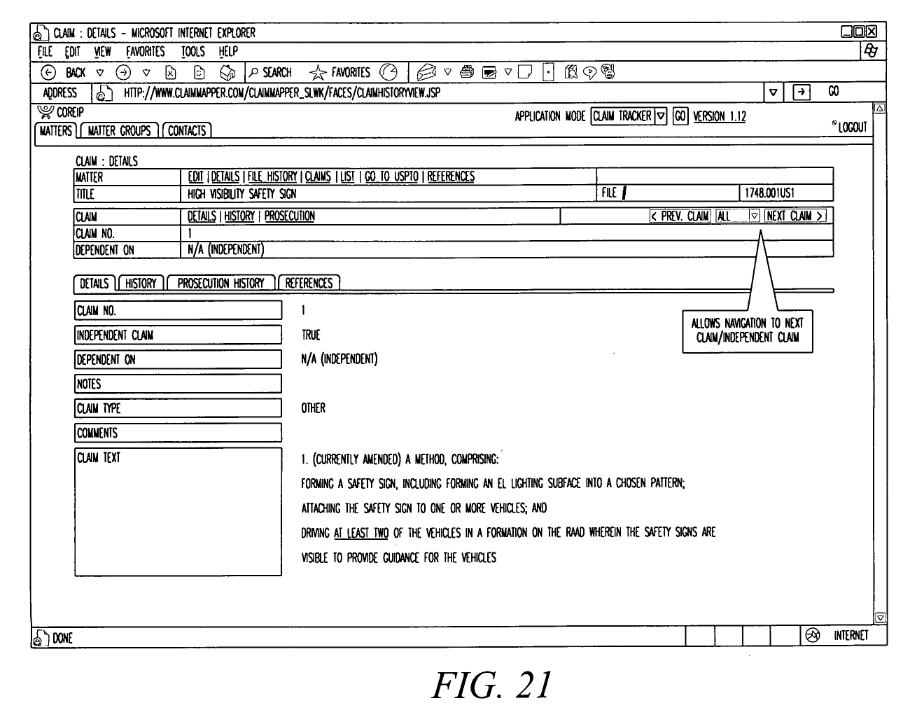

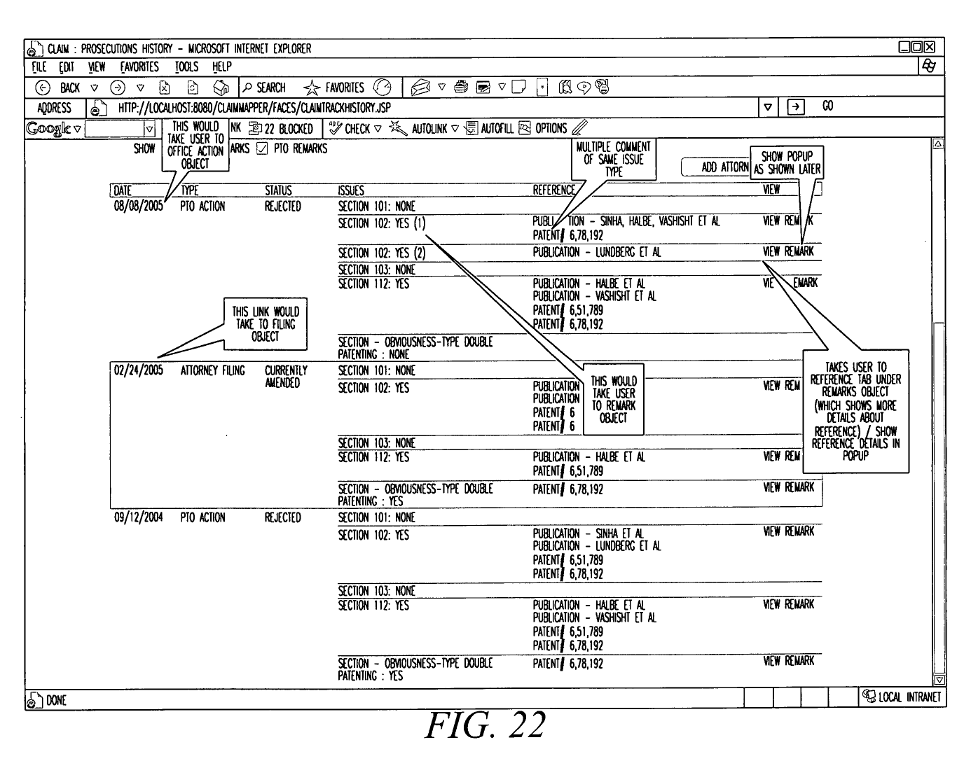

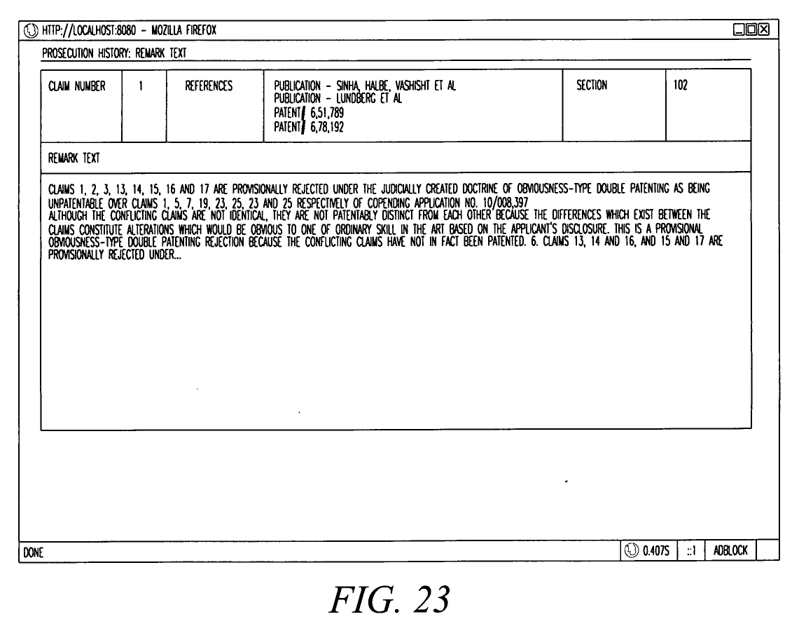

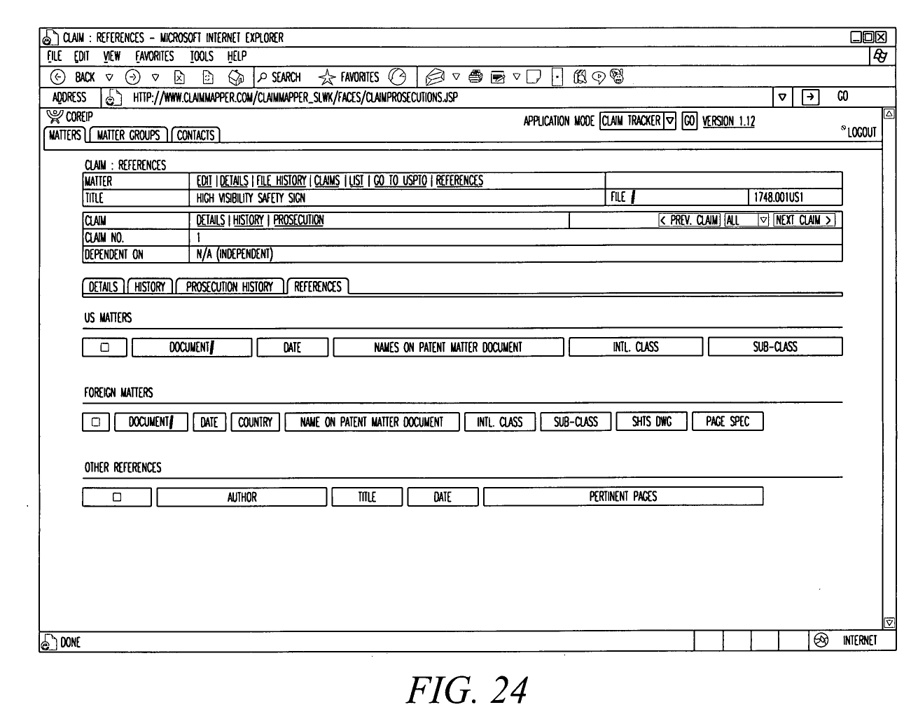

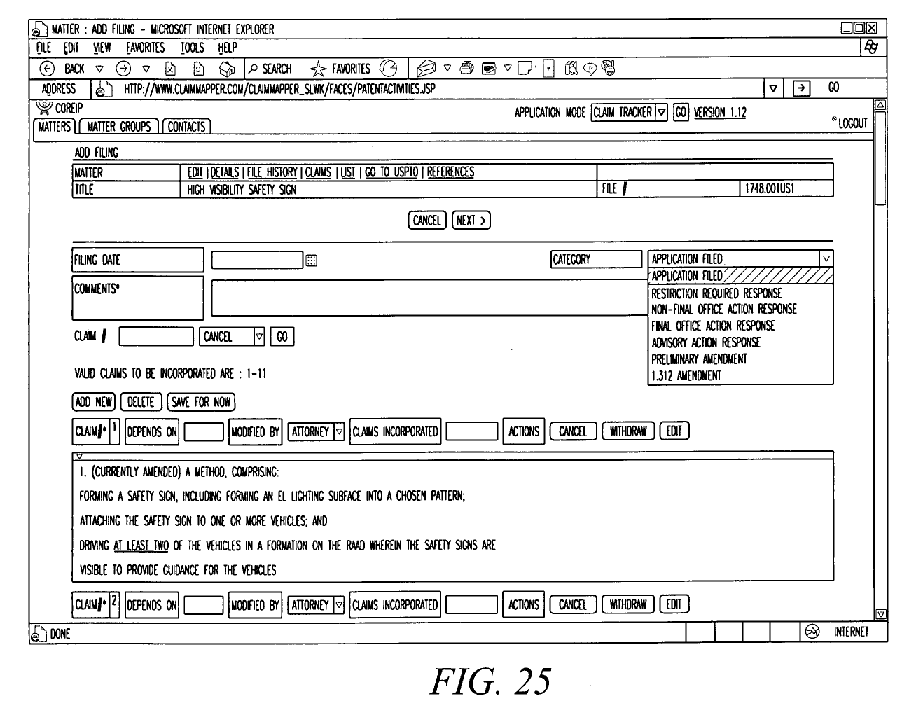

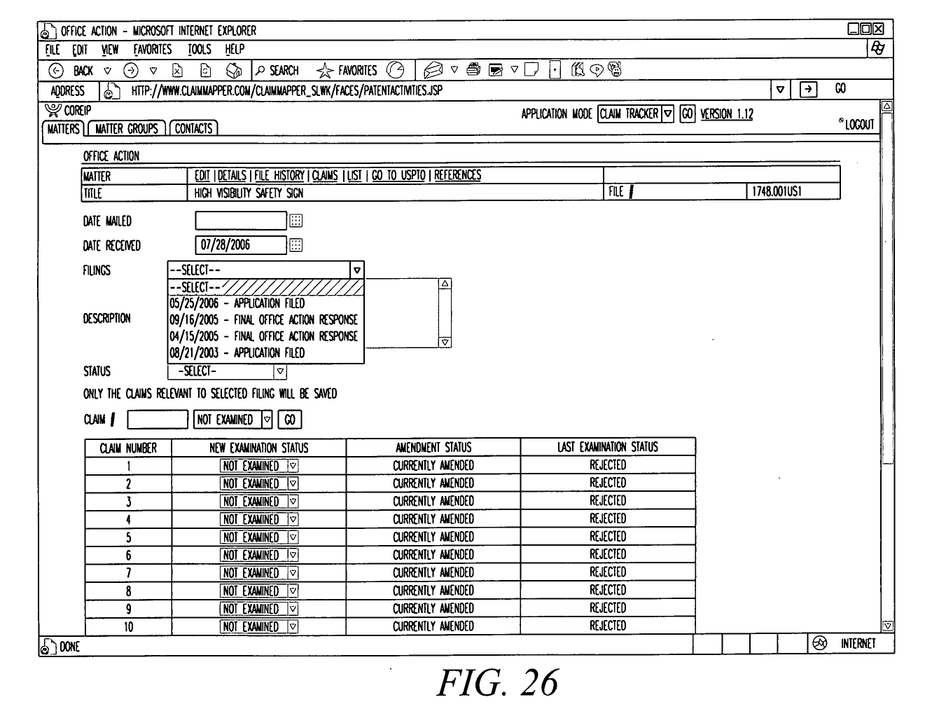

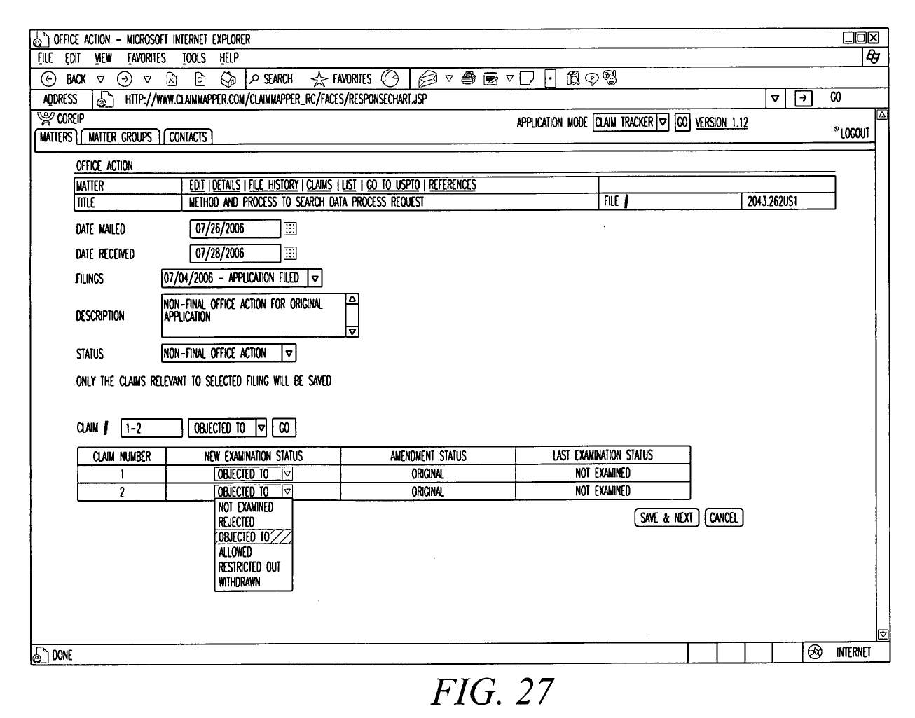

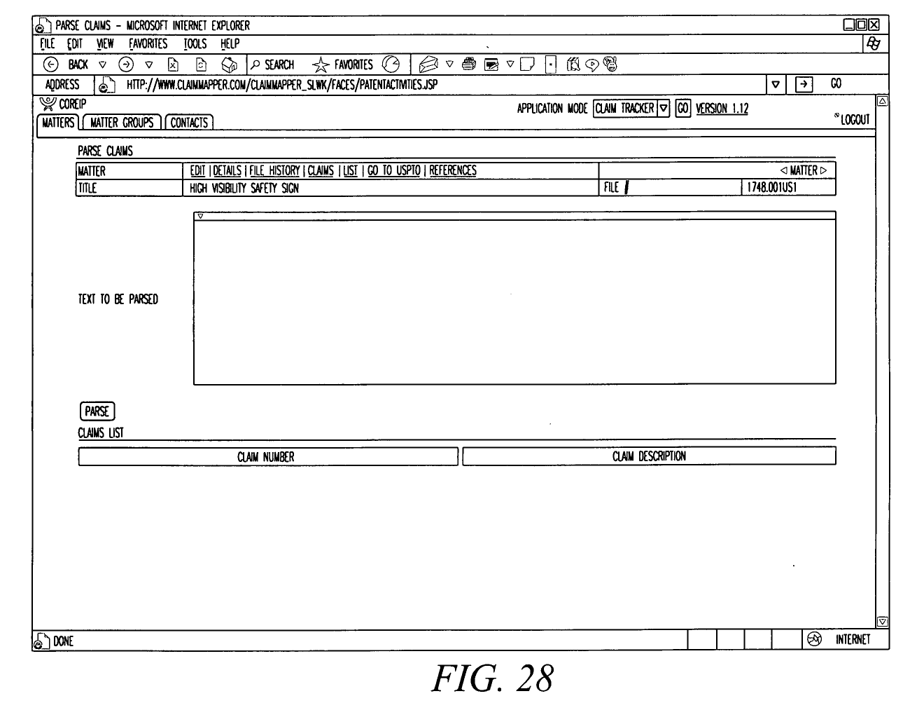

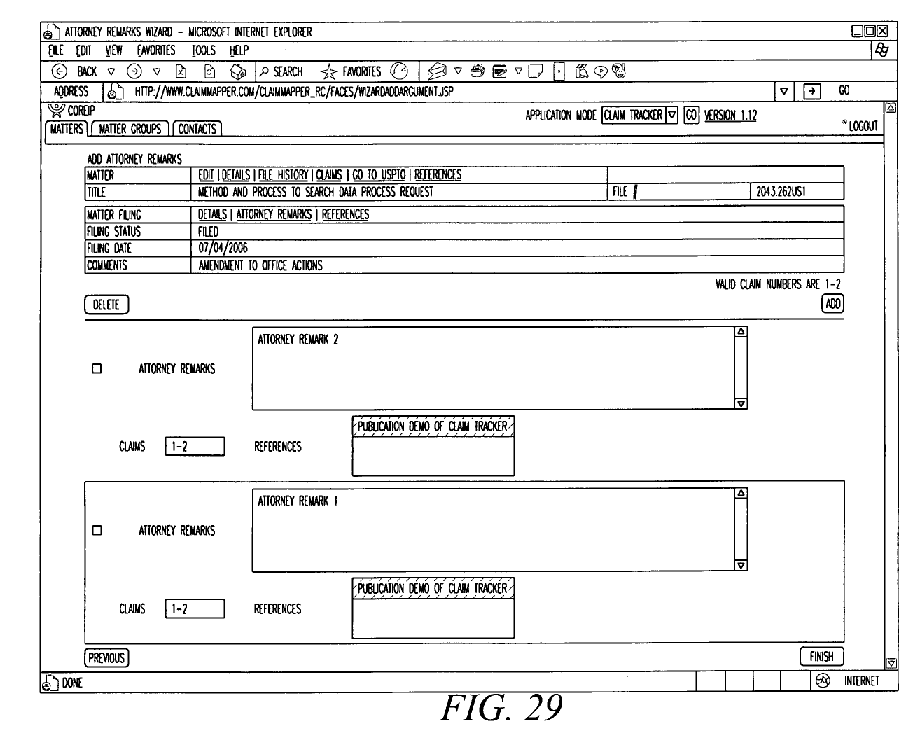

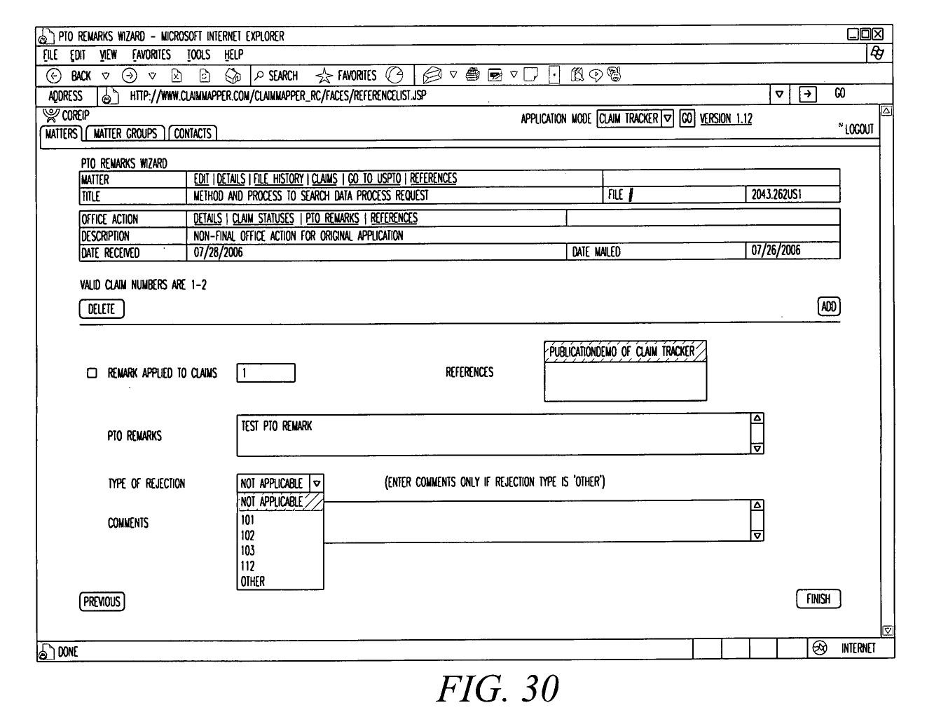

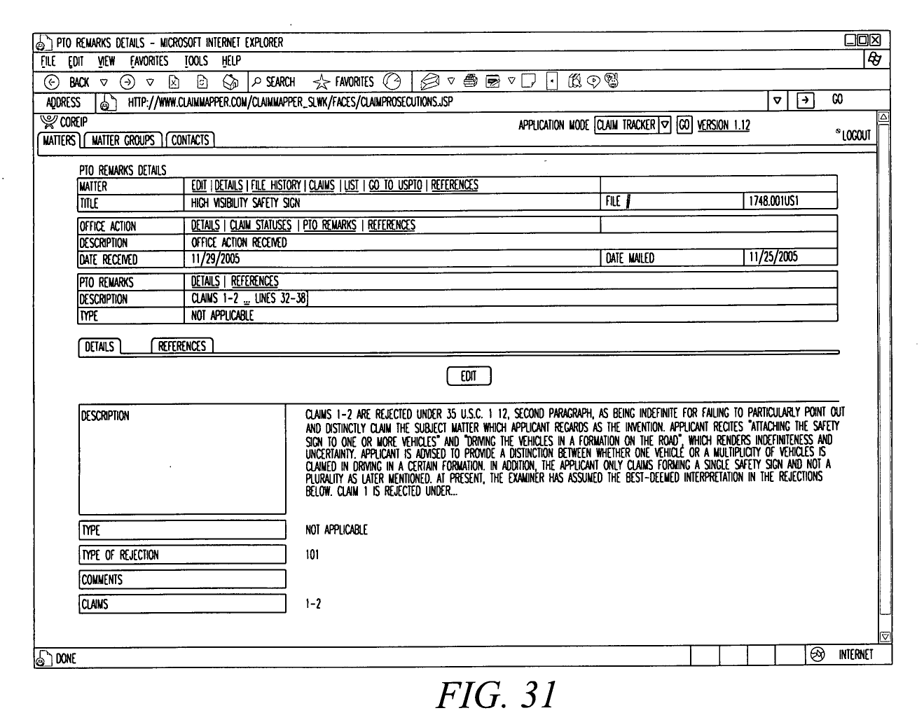

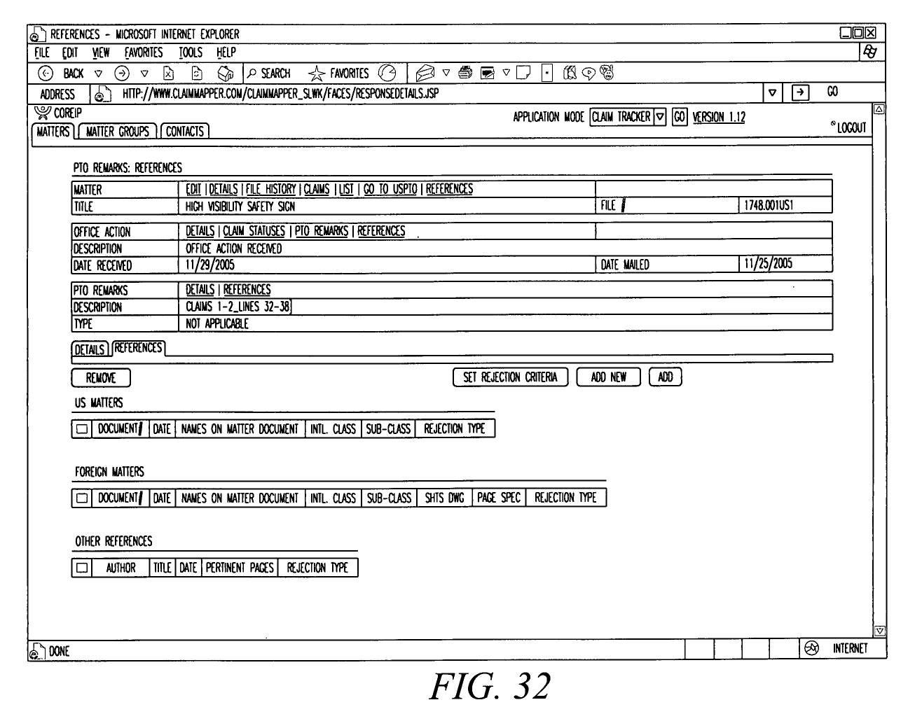

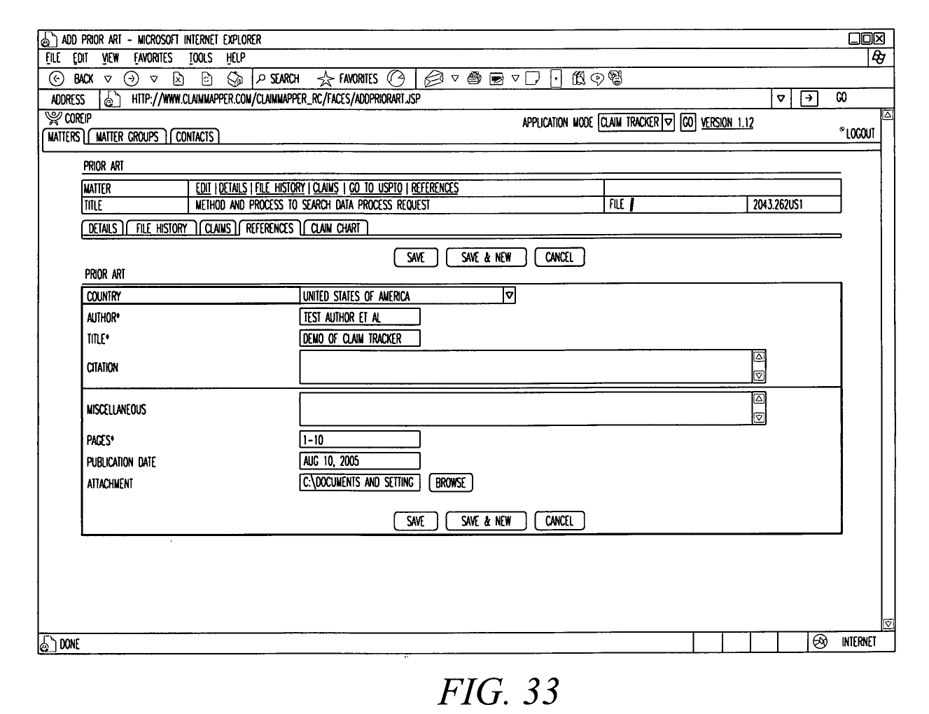

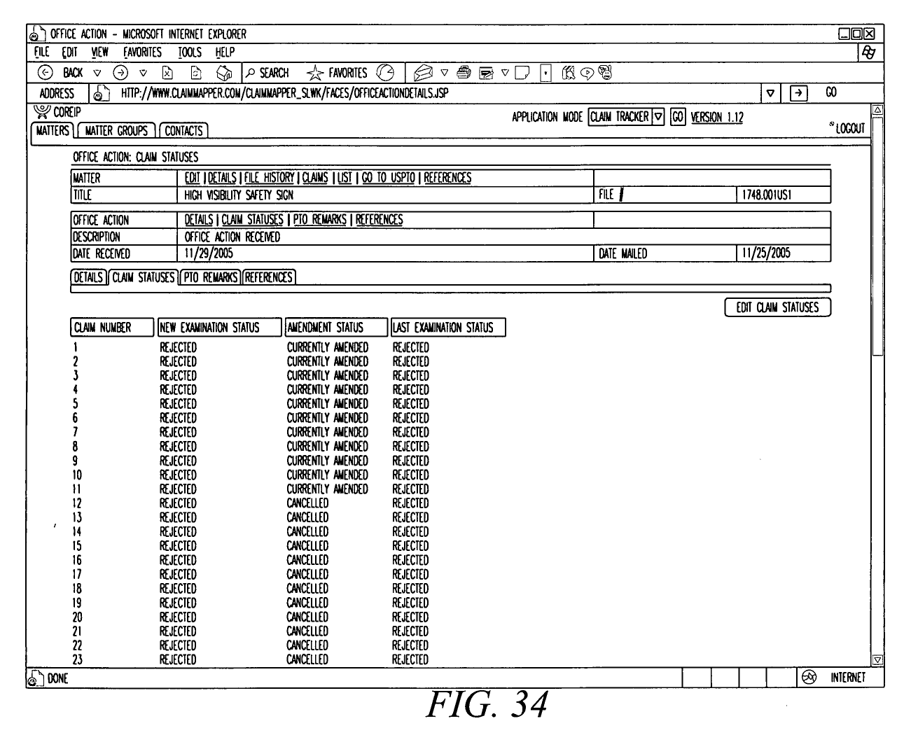

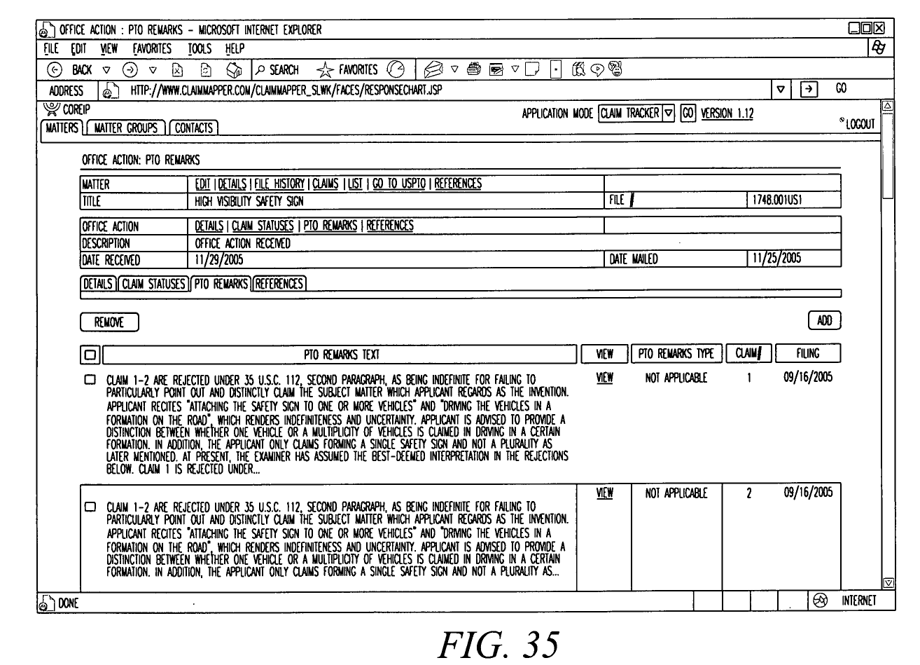

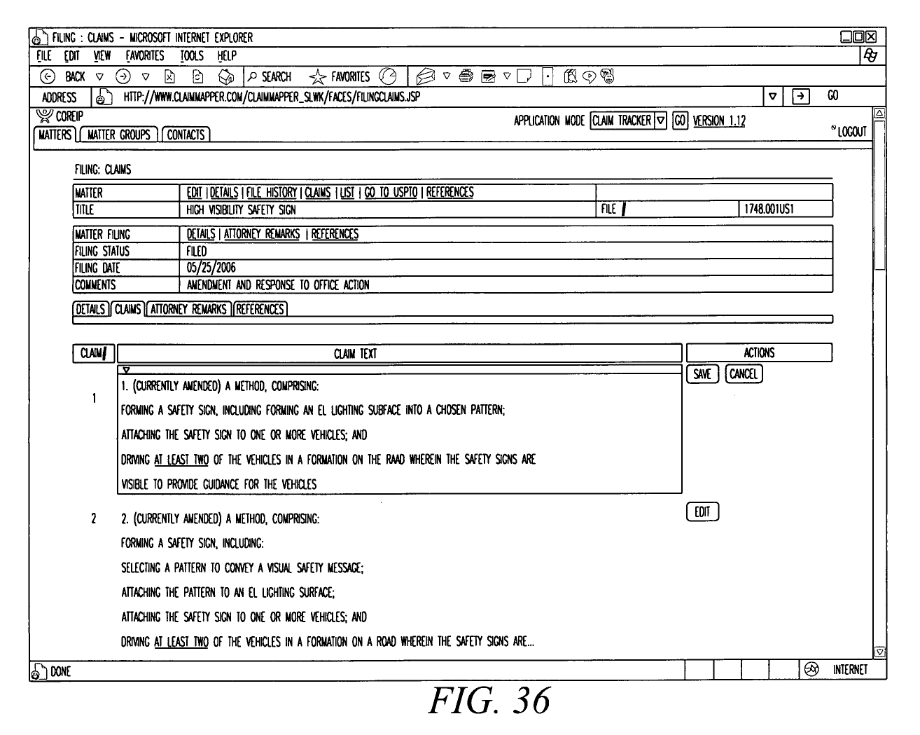

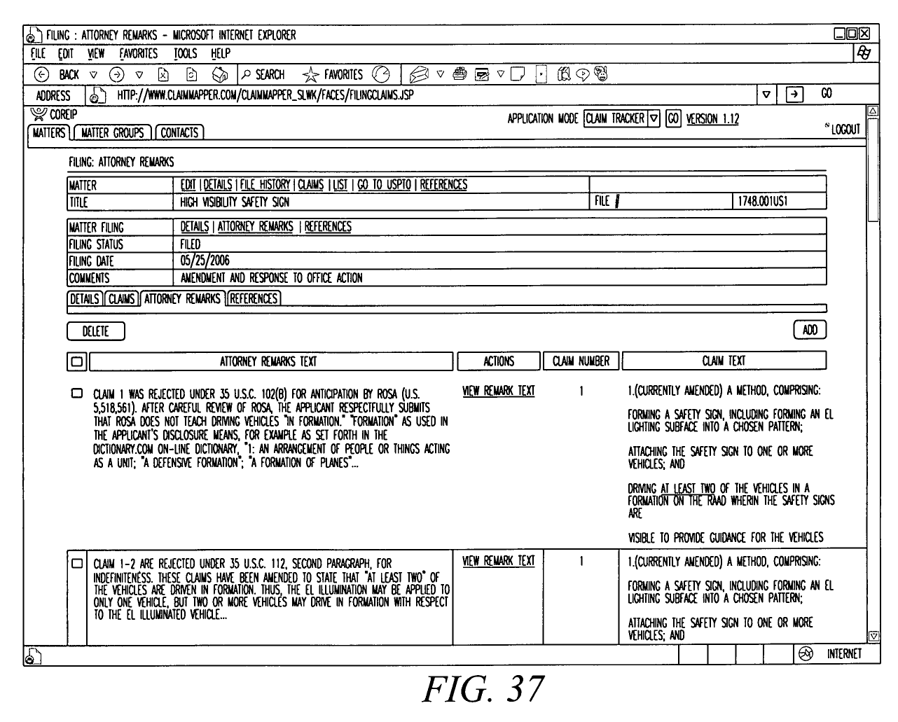

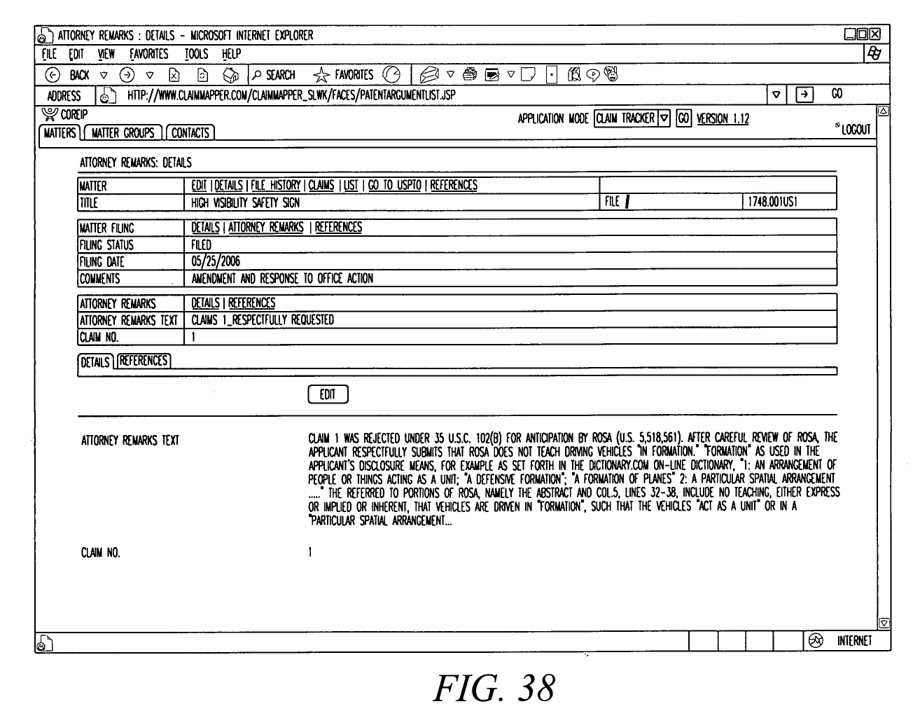

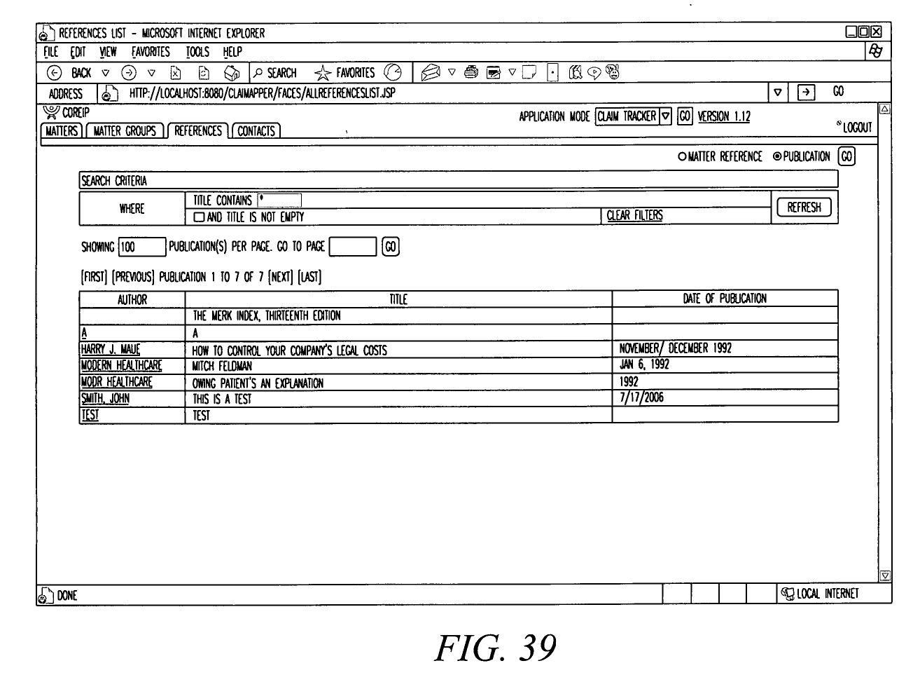

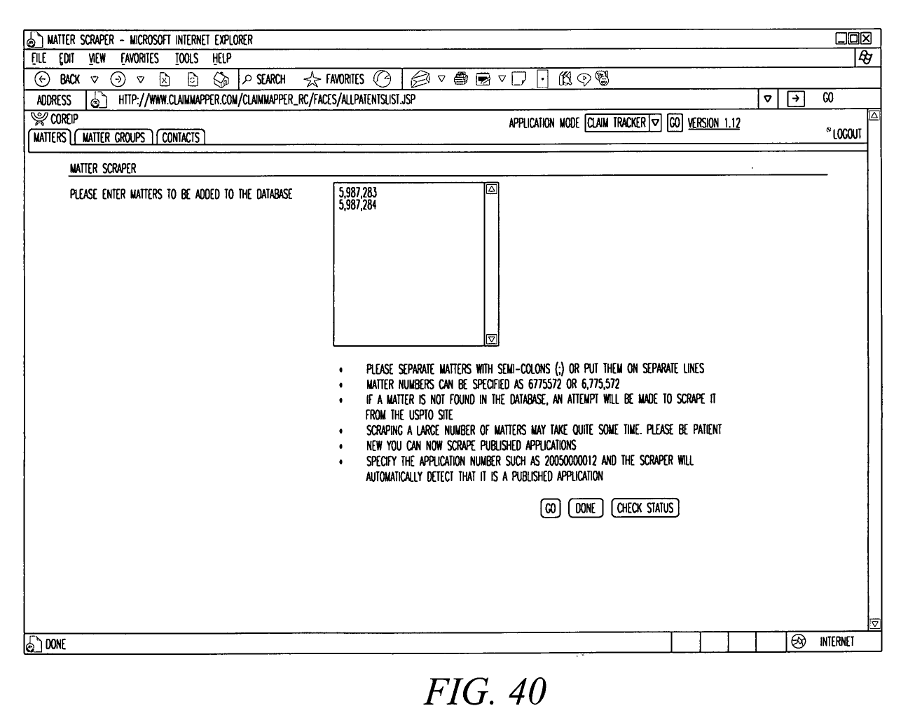

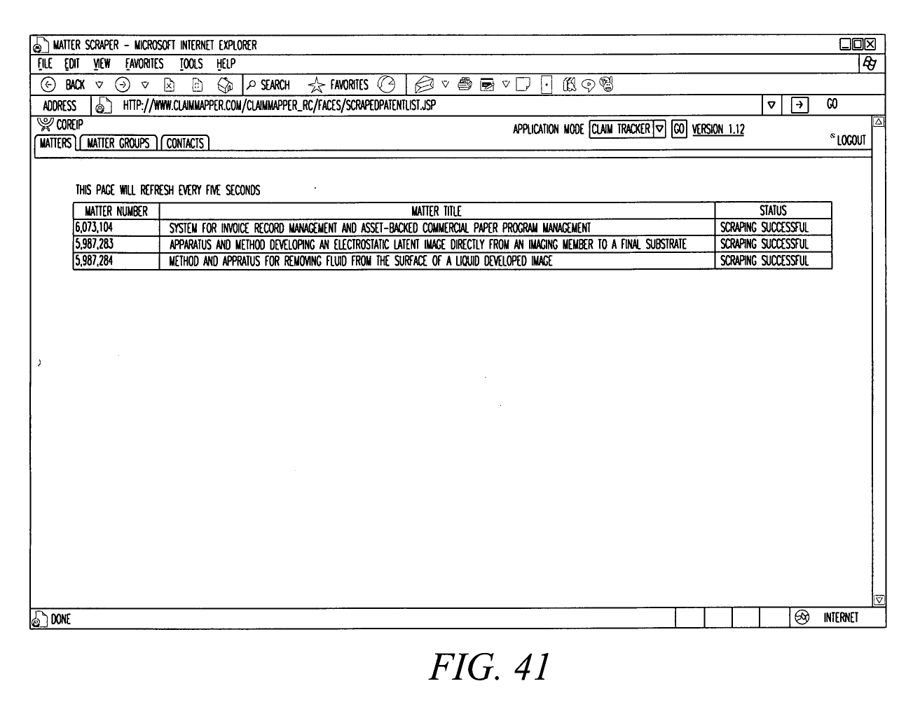

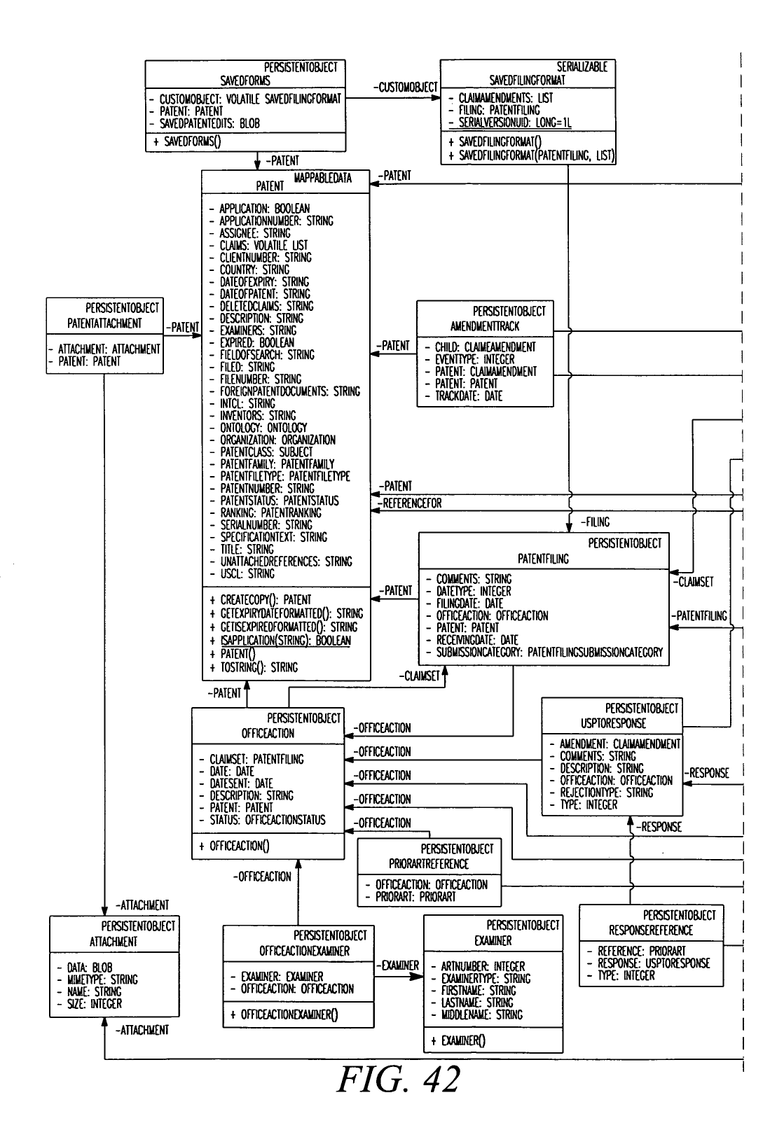

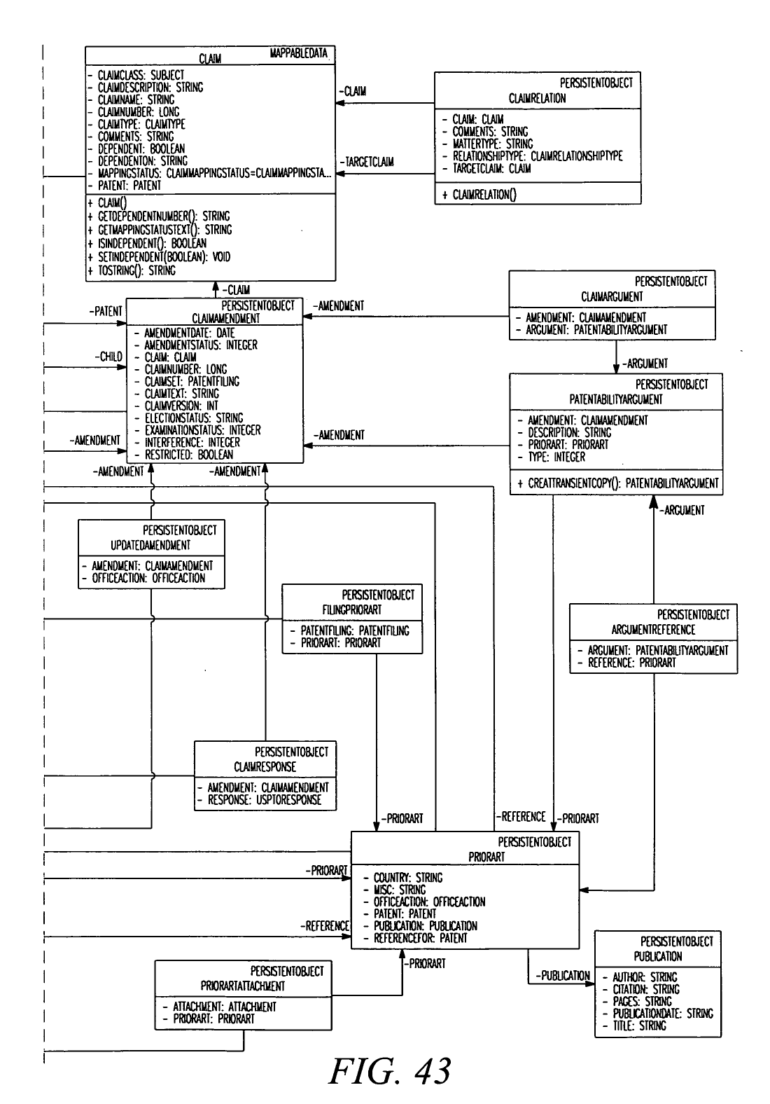

FIGS. 4-43 are graphical illustrations of screenshots of a claim tracking tool according to various embodiments. These screenshots show the functions of a claim tracking tool interface which may be used to follow and record patent application through prosecution. FIGS. 2-43 illustrate a graphical user interface which may include a matter view and a matter groups view. The matter groups view may include one or more matters to be viewed in the matter view. Additionally, the matter view may include one or more sub-views which may include a details sub-view, a file history sub-view, a claims sub-view, a references sub-view, or a claim chart sub-view. The graphical user interface may include but is not limited to the following:
A Matter: list View—Allows user to enter search for a specific matter with a file#, Matter#, Application#.
A search that allows wild card searches.
Matter Groups—Allows logical grouping of matters.
Matter Group: Matter List—Matters forming a logical grouping are added to matter group. Matters may be added from existing list of matters in the system or patents can be scraped off USPTO web site and added to the matter group.
Matter: Details—More details about matter under prosecution. These can be edited in place using edit functionality.
Matter: File History—Matter will go through cycle of application, possible preliminary amendments, office actions of different kinds, amendments of different kinds. This view shows complete history of all these actions till this date.
Matter: Claims—Various versions of all the claims in matter can be seen from here. It offers different views like—Red line text view, Claim History view. Claim text is formatted in a format preferred by attorneys.
Matter Group: claims: history—All history view, an expanded version of recent history view. It shows claim text with various PTO comments and Attorney comments made on each claim till this date.
Matter Group: claims: prosecution—Recent history view. It shows claim text with only latest PTO comment and Attorney comment made on each claim.
Matter Group: claims—Red line text view (marked-up view)
Matter: References—All references cited in favor or against chosen matter in various office actions and filings.
Prior Art/References—Form for addition of references
Matter: Claim Chart—This screen may give a complete overview of matter at claim level. It shows evolution of claim status values from original application filing till the latest office action/amendment.
Matter: Editor—Allows editing of matter details
Claims: History View—This view shows evolution of claim language for a claim. This screen allows comparison of claim language across different versions (difference is presented in Red-lined text format)
Claim: Details—Display details about a claim. All these views are available for each claim of the matter.
Claim: Prosecution History—Shows a summary view of prosecutions that have happened on current claim.
Prosecution History: Remark Text—This is a pop-up shown when a link on prosecution history view (see above) is clicked.
Claim: References—This view shows references as cited in remarks against or in favor of this claim.
Add Filing—Allows user to add different kinds of filings (as shown in the category dropdown in the diagram). During filing, new claims can be added, amended, withdrawn, or canceled.
PTO Remarks: Details

In another embodiment, claims can also be mapped to Features. A Feature is any arbitrary definition of a feature of a product/service or technology. A claim is mapped as one or more of the following: does not cover the Feature; covers the Feature generically (i.e., provides genus coverage for the described feature), or it covers only a species of the Feature. Hierarchies of Features may be created in family-genus-species arrangements, such that claim coverage for each mapped claim may be tracked, mined or displayed in terms of which Features are covered generically or only certain species are covered. In addition, Features may also be mapped to Products, so that patent coverage for a Product may be expressed in terms of which claims cover the various features of the Product. With ClaimTracker capabilities, the status of the claims may also be displayed. Also, Feature mapping may be used to track infringement situations or portfolio coverage situations.

It is to be understood that the above description is intended to be illustrative and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

For the purposes of this specification, the term “machine-readable medium” or “computer-readable medium” shall be taken to include any medium which is capable of storing or encoding a sequence of instructions for execution by the machine and that cause the machine to perform any one of the methodologies of the inventive subject matter. The terms “machine-readable medium” or “computer-readable medium” shall accordingly be taken to include, but not be limited to, solid-state memories, optical and magnetic disks, and carrier wave signals. Further, it will be appreciated that the software could be distributed across multiple machines or storage media, which may include the machine-readable medium.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The foregoing description of specific embodiments reveals the general nature of the inventive subject matter sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The detailed description does not, therefore, limit the scope of the invention, which is defined only by the appended claims.

1. A graphical user interface for tracking patent prosecution data, the graphical user interface comprising:
a matter view; and
a matter groups view,
wherein the matter groups view includes one or more matters to be viewed in the matter view, and wherein the matter view includes one or more sub-views selected from the group of a details sub-view, a file history sub-view, a claims sub-view, a references sub-view, or a claim chart sub-view.

2. The graphical user interface of claim 1, wherein the details sub-view includes at least a matter identification field, an inventors field, an assignee field, an application number field, a serial number field, a client identification field, or a file status field.

3. The graphical user interface of claim 1, wherein the file history sub-view includes one or more PTO correspondences.

4. The graphical user interface of claim 1, wherein the claims sub-view includes a version selection control to select a version of the claims that correspond to a PTO correspondence, and one or more claims presented with detailed information, the detailed information including a claim number, a claim text, an amendment status, an examination status, and one or more links to a claim history, a claim prosecution, or a red-lined version.

5. The graphical user interface of claim 4, wherein the claim history link directs a user to a claim history view, wherein the claim history view includes a complete prosecution history for a selected one or more claims.

6. The graphical user interface of claim 4, wherein the claim prosecution link directs a user to a claim prosecution view, wherein the claim prosecution view includes a latest PTO comment for a selected one or more claims.

7. The graphical user interface of claim 4, wherein the red-lined version link directs a user to a red-lined claim view, wherein the red-lined claim view includes added content in underlined text and deleted content in strikethrough text.

8. The graphical user interface of claim 1, wherein the references sub-view includes zero or more related reference documents.

9. The graphical user interface of claim 1, wherein the claim chart sub-view includes a table comprising one or more rows, wherein each row corresponds to a claim, and wherein each row includes a claim number field, and one or more filing status and office action status pairs, wherein the filing status corresponds with a claim status as filed and wherein the office action status corresponds with a responsive office action status of the claim after examination.

10. A method for tracking patent application data comprising:
recording a claim related to the patent application;
recording an amendment to the claim; and
displaying the claim with one or more markups to show the change between the claim and the amendment to the claim.

11. The method of claim 10, further comprising displaying an identifier to illustrate that the claim has an amendment.

12. The method of claim 10, further comprising recording a further amendment to the claim and displaying the claim with one or more markups to show the change between the claim, the amendment to the claim, and the further amendment to the claim.

13. The method of claim 10, wherein the markups use underlines to indicate additions and strikethroughs to indicate deletions.

14. The method of claim 10, further comprising allowing a user to select a view of the claims to be displayed.

15. A system for tracking patent application data comprising:
an interface to record a communication related to the patent application;
a reference module to record a reference from the communication with respect to one or more claims in the patent application; and
a reference display module to display the reference to show an association between the reference and the communication.

16. The system of claim 15, wherein the reference display module further displays the reference to show an association between the reference and the claim.

17. The system of claim 15, further comprising a claims display to display the claim to show an association between the claim and the reference.

18. The system of claim 15, wherein the reference is associated with a plurality of communications.

19. The system of claim 18, wherein the reference is associated with a plurality of patent applications.

20. The system of claim 19, wherein the display module further displays the reference to show an association between the reference and each associated communication and patent application.

21. The system of claim 19, further comprising a claims display module to display a relation of one or more claims from one or more patent applications having the same associated reference.
